(19) United States
(12) Patent Application Publication
(10) Pub. No.: US 2007/0229827 A1
(43) Pub. Date: Oct. 4, 2007

(54) OPTICAL MONITORING OF PRODUCTS OF THE TOBACCO-PROCESSING INDUSTRY

(75) Inventors: Roland GAST, Hamburg (DE); Michael IBEL, Halstenbek (DE)

Correspondence Address: GREENBLUM & BERNSTEIN, P.L.C., 1950 ROLAND CLARKE PLACE, RESTON, VA, 20191, US

(73) Assignee: HAUNI MASCHINENBAU AG, Hamburg (DE)

(21) Appl. No.: 11/673,868

(22) Filed: Feb. 12, 2007

(30) Foreign Application Priority Data
Feb. 27, 2006 (DE) 10 2006 009 482.4

(51) Int. Cl. G01B 11/00

(52) U.S. Cl. 356/390

(57) ABSTRACT

The invention relates to an apparatus and method for electromagnetic monitoring of products of tobacco-processing industry in a monitoring zone. An apparatus includes a first imaging device aligned to the monitoring zone, a second imaging device aligned to the monitoring zone from a direction different from the first imaging device, and an evaluating device structured and arranged to evaluate image data recorded by the first and second imaging devices. At least one of the first and second imaging devices is aligned to at least one product. The instant abstract is neither intended to define the invention disclosed in the specification nor intended to limit the scope of the invention in any way.

### CROSS-REFERENCE TO RELATED APPLICATIONS

The present application claims priority under 35 U.S.C. §119 of German Patent Application No. 10 2006 009 482.4, filed on Feb. 27, 2006, the disclosure of which is expressly incorporated by reference herein in its entirety.

### BACKGROUND OF THE INVENTION

1. Field of the Invention

The invention relates to a device and a method for the electromagnetic, in particular optical, monitoring of products of the tobacco-processing industry in a monitoring zone, and to a machine of the tobacco-processing industry that includes a device of this type.

2. Discussion of Background Information

Within the scope of the invention, products of the tobacco-processing industry refers to rod-shaped and strip-shaped products and objects such as cigarettes, filter rods, multisegment filter rods, cigarette paper or tipping paper, and stamp imprints on paper webs or glue application on paper webs.

In the optical monitoring of this type of products of the tobacco-processing industry, quality features (such as, for example, the presence of holes, smudges, damage, etc.) on the products are generally checked and evaluated.

German patent application DE 34 20 470 A1 (of which U.S. Pat. No. 4,639,592 is a U.S. patent family member) describes a device for the optical testing of the wrapping of rod-shaped articles of the tobacco-processing industry with a rotating conveyance for conveying the articles in a transverse axial manner through a testing zone in a row in a single layer and with an optical testing unit aligned to the testing zone. The device includes an illuminating unit illuminating an axially parallel circumferential section of each article passing through the testing zone and an optoelectrical sensor with a row of optoelectrical detector units assigned to different longitudinal sections of the illuminated article surface to record the light reflected on the article surface. The testing zone thereby has at least one first and one second testing zone section, whereby at least one optical testing unit is aligned to each testing zone section and whereby the circumferential sections of the articles covered during passage through the first testing zone section face the optical testing unit during passage through the second testing zone section. In this manner a testing device for the optical testing of rod-shaped articles of the tobacco-processing industry is disclosed, which is designed to guarantee reliable information on the condition of the entire article surface. However, there is a certain probability that particles flying about, such as, for example, tobacco dust, will interfere with the optical monitoring so that false evaluations occur.

A method for monitoring the external integrity of cigarettes is known from printed patent specification EP 0 812 548 B1, in which cigarettes are conveyed along a path in a feed direction with the aid of a conveyor. The cigarettes pass through the section of a monitoring path where they are tested for their external properties with the use of optical multiline scanning devices. Each separate optical scanning corresponds to an individual line from a bundle of parallel lines arranged lengthwise next to one another. If a cigarette is rotated about its own longitudinal axis along its feed direction, it is possible to scan more than once along the same line, based on the cylindrical surface of the cigarette. In this manner, dirt particles between the cigarette and the optical scanning device which move relative to the cigarette can be detected as such and are not falsely regarded as defects in the cigarette.

### SUMMARY OF THE INVENTION

The present invention relates to a device and a method with which false evaluations of products of the tobacco-processing industry are avoided according to which intact products are considered defective. The present invention further relates to machine which includes a device of this type.

According to a first aspect of the invention, there is a device for the electromagnetic, in particular optical, monitoring of products of the tobacco-processing industry in a monitoring zone, comprising a device for evaluating the images recorded by imaging devices and at least two imaging devices aligned to the monitoring zone from different directions. At least one of the imaging devices is aligned to at least one product.

In a preferred embodiment of the device, two imaging devices are aligned to the at least one product.

According to embodiments of the invention, the device has the advantage that the surface of a product of the tobacco-processing industry (e.g., cigarette) is recorded from at least two different viewing angles. The surface of the product is thus imaged at least twice (i.e., several times). In this manner foreign particles located in the monitoring zone between the surface of the product and the imaging devices (i.e., not on the product surface) are shown on the images of the imaging devices respectively at different positions relative to the product, to which particles no unambiguous position on the product surface can be assigned via the evaluating device. As used herein, surface of the product refers to a partial area of the surface of a product or surfaces of several products.

In a preferred embodiment, the imaging devices are aligned to the monitoring zone essentially perpendicular to one another. For example, this can be an arrangement in which one imaging device records a product frontally to its cylindrical outer surface, and another imaging device is directed to the monitoring zone such that the product is not thereby detected.

In another embodiment, the device has an apparatus for illuminating the monitoring zone.

In accordance with aspects of the invention, a device is preferably provided for conveying the products through the monitoring zone in a row one behind the other in a single layer. By conveying in a row in a single layer, which row can also have multiple lanes, it can be ensured that the imaging devices can actually monitor each product conveyed past.

In embodiments, there is a machine of the tobacco-processing industry which includes one of the above-mentioned devices.

According to further aspects of the invention, there is a method for the electromagnetic, in particular optical, monitoring of products of the tobacco-processing industry in a monitoring zone. In implementations, the monitoring zone is recorded by imaging devices from at least two different directions, whereby at least one image of at least one product is recorded, and the images are evaluated to find out whether there is an irregularity in the at least one product. The evaluation is thereby carried out in particular in that the images recorded by the imaging devices are relayed as data to an evaluating device in which the data of the at least two imaging devices are combined and evaluated.

A preferred embodiment of the method lies in that the monitoring zone is recorded from precisely two different directions. In a particularly preferred embodiment, the at least one product is thereby recorded by two imaging devices from different directions. For example, the evaluation of the images is advantageously carried out by an irregularity on the surface of the product being assumed whenever an irregularity occurs on the two images at such positions that precisely one point on the surface can be assigned to these two positions. Preferably, no irregularity on the surface of the product is assumed whenever one clear point on the surface cannot be assigned to an irregularity on the two images.

In such implementations, an irregularity (e.g., a hole or a smudge on the surface of cigarette) is assumed only when both images display the position of an irregularity such that precisely one point on the surface of the cigarette is possible for it. If this is not the case (i.e., if the irregularity is established at two different positions on the images), this inconsistency can be solved in that the irregularity is caused by a foreign particle in the monitoring zone between the surface of the product (e.g., a cigarette) and the imaging devices. In this case, the evaluation according to embodiments of the invention shows that there is no irregularity on the surface of the product. If no irregularity is recorded on either of the images, no irregularity is assumed to be on the product either. Consequently, a product of this type is not discarded as defective.

Another variant of the method according to embodiments of the invention is that with images of the monitoring zone from two different directions, the product is recorded only once by one image. For example, the evaluation of the two images is advantageously carried out in that an irregularity on the surface of the product is assumed whenever an irregularity is established on only one of the two images. That is, an irregularity on the surface of the product is assumed when an irregularity is established on the image that is assigned to the imaging device which records the monitoring zone with the product to be tested, while the imaging device that records the monitoring zone without the product does not show an irregularity. If the case occurs that both images show irregularities, this irregularity can be explained in that the irregularity displayed by both imaging devices is caused by a foreign particle located in the monitoring zone between the surface of the product and the imaging devices. If neither of the two imaging devices shows an irregularity, it is assumed that there is no irregularity on the surface of the product and that there is no foreign particle either in the monitoring zone between the surface of the product and the imaging devices.

For optical monitoring, line cameras or matrix cameras are generally used as imaging devices, which cameras as a rule are equipped with expensive large lenses due to the high requirements in terms of imaging and resolution quality.

The illumination of the products of the tobacco-processing industry in their role as measuring objects of the imaging devices is realized with separate light sources which should have high light intensity due to the large distance from the object. It is also known, among other things, to bring the light to the measuring object by fiber optic cables with losses of intensity.

In implementations of the invention, the evaluating device is embodied, for example, as a computer and/or machine central computer. The measured values stored by the imaging devices are relayed to the evaluating device and evaluated there when combined with one another.

In embodiments, a calibration of the apparatus, in particular of the imaging devices and the evaluating device, is carried out before an evaluation of this type so that the subsequent evaluation of the images leads to the correct conclusions regarding the presence of an irregularity on the surface of a product.

In a first aspect of the invention there is an apparatus for electromagnetic monitoring of products of tobacco-processing industry in a monitoring zone, comprising: a first imaging device aligned to the monitoring zone; a second imaging device aligned to the monitoring zone from a direction different from the first imaging device; and an evaluating device structured and arranged to evaluate image data recorded by the first and second imaging devices. At least one of the first and second imaging devices is aligned to at least one product.

In embodiments, the first and second imaging devices are aligned to the at least one product. In additional embodiments, the first and second imaging devices are aligned to the monitoring zone essentially perpendicular to one another.

The apparatus may further comprising an apparatus structured and arranged to illuminate the monitoring zone.

The apparatus may further comprise a conveying apparatus for conveying the at least one product through the monitoring zone. Moreover, the at least one product may comprise plural products, and the conveying apparatus conveys the plural products through the monitoring zone in a row, one behind an other, in a single layer.

The first and second imaging devices may comprise optical imaging devices.

The evaluating device compares first image data of the first imaging device to second image data of the second imaging device. In implementations, the evaluating device is structured and arranged to: assume a defect on a surface of the at least one product when a first irregularity in the first image data and a second irregularity in the second image data coincide with a point on the surface of the at least one product, and assume no defect on a surface of the at least one product when no point on the surface of the at least one product coincides with a first irregularity in the first image data and a second irregularity in the second image data. In additional implementations, the evaluating device is structured and arranged to: assume a defect in the at least one product when only one of the first and second image data contains an irregularity, and assume no defect in the at least one product when both the first and second image data contains an irregularity or when no image data contains an irregularity.

In another aspect of the invention, there is a machine of the tobacco-processing industry comprising an apparatus for electromagnetic monitoring of products of tobacco-processing industry in a monitoring zone, comprising: a first imaging device aligned to the monitoring zone; a second imaging device aligned to the monitoring zone from a direction different from the first imaging device; and an evaluating device structured and arranged to evaluate images recorded by the first and second imaging devices. At least one of the first and second imaging devices is aligned to at least one product.

In yet another aspect of the invention, there is a method of electromagnetic monitoring of products of tobacco-processing industry in a monitoring zone. The method comprises recording a first image of the monitoring zone from a first direction; recording a second image of the monitoring zone from a second direction different from the first direction, wherein at least one of the first image and the second image includes at least one image of at least one product; and determining whether there is a defect in the at least one product by evaluating the first image and the second image.

In embodiments, both the first image and the second image include at least one image of the at least one product. The evaluating may comprise assuming a defect on a surface of the at least one product when a first irregularity in the first image and a second irregularity in the second image coincide with a point on the surface of the at least one product. The evaluating may comprise assuming no defect on a surface of the at least one product when no point on the surface of the at least one product coincides with a first irregularity in the first image and a second irregularity in the second image.

In embodiments, only the first image includes the at least one image of the at least one product. The evaluating may comprise assuming a defect on a surface of the at least one product when only the first image contains an irregularity. The evaluating may comprise assuming no defect on a surface of the at least one product when both the first image and the second image contain an irregularity or when no image contains an irregularity.

The at least one product may comprise plural products, and the method further comprises conveying the plural products through the monitoring zone in a row, one behind an other, in a single layer.

In implementations, the evaluating comprises comparing the first image and the second image.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a device according to aspects of the invention with two imaging devices, both of which are aligned to the product; and

FIG. 2 shows an embodiment of the device according to aspects of the invention with two imaging devices, one of which is aligned to the product.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the following figures, the same or same kind of elements or corresponding parts are provided with the same reference numbers so that a corresponding repeated introduction has been omitted.

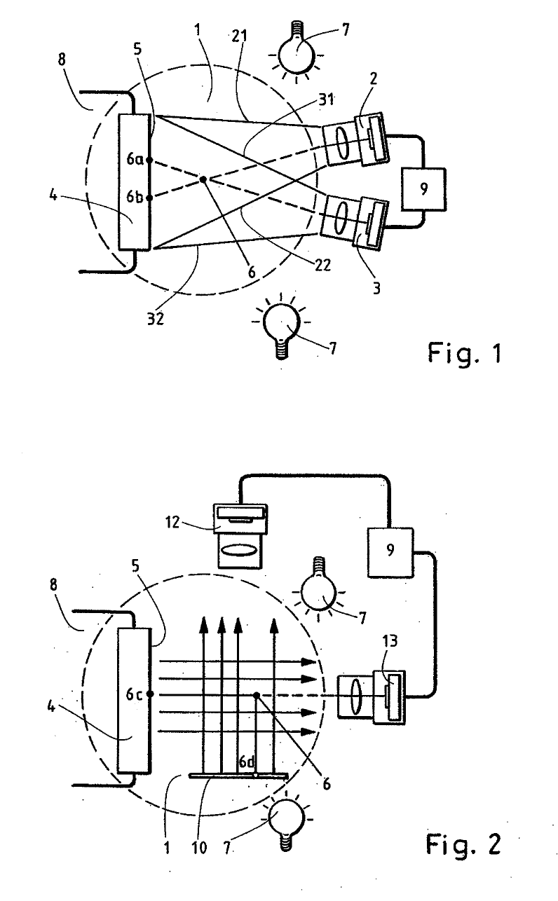

FIG. 1 shows an embodiment of the device according to the invention in diagrammatic form. A product 4 of the tobacco-processing industry (e.g., a cigarette rod) is located in a monitoring zone 1 through which the product 4 is moved by a device 8 in a row in a single layer. The monitoring zone 1 is represented by a dotted line in the form of a closed curve. A device 7 is used to illuminate the monitoring zone 1, in particular the surface 5 of the product 4. Two imaging devices 2, 3 are aligned to the surface 5, which imaging devices are connected to a device 9 for evaluating the images recorded by the imaging devices 2, 3. The two imaging devices 2, 3 are arranged displaced and at an angle to one another such that the surface 5 is recorded from different directions. Furthermore, a particle 6 is shown in the monitoring zone 1 between the surface 5 and the imaging devices 2, 3, which particle is, for example, a dirt particle or a tobacco crumb. An image by the imaging device 2 will reflect the particle 6 as an irregularity in the position 6b on the surface 5 of the product 4, as shown by the course of the corresponding dotted line to position 6b. However, an image by the imaging device 3 will reflect the particle 6 as an irregularity in position 6a on the surface 5 of the product 4, as shown by the course of the corresponding dotted line to position 6a. The areas recorded by the two imaging devices 2, 3 are respectively delimited by straight lines 21, 22 and 31, 32. The two images are relayed to the evaluating device 9. There the data belonging to the images are compared to one another, whereby an irregularity is established at two positions 6a and 6b. Since the two positions 6a and 6b do not coincide, the evaluating device 9 evaluates this measurement result in that no irregularity is present on the surface 5 of the product 4.

FIG. 2 shows an embodiment of the device according to the invention with two imaging devices 12, 13, of which the imaging device 13 is aligned to the monitoring zone 1 and to the surface 5 of the product 4, and the imaging device 12 is aligned to the monitoring zone 1, but not to the surface 5. The two imaging devices 12, 13 are aligned to the monitoring zone 1 essentially perpendicular to one another.

An image by the imaging device 13 shows the particle 6 as an irregularity at the position 6c on the surface 5 of the product 4. An image by the imaging device 12 likewise reflects the particle 6, namely as an irregularity in position 6d, if a projection area 10 is taken as a basis for the image, which however does not represent a necessary feature, but can merely serve to increase the contrast. The images of the two imaging devices 12, 13 respectively show an irregularity in the positions 6c and 6d. The images are relayed to the evaluating device 9, where these measured data are evaluated in that an irregularity that is found both in the image by the imaging device 12 in position 6d, and in the image by the imaging device 13 in position 6c, can be caused only by a particle 6 (e.g., a dirt particle, a tobacco crumb, etc.) in the monitoring zone 1 between the surface 5 of the product 4 and the imaging devices 12, 13.

The projection area 10 can also be embodied as an illuminating element. To this end, in particular a flat lighting element or a lit bright area can be used.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### REFERENCE NUMBERS

1 Monitoring zone

2 Imaging device

3 Imaging device

4 Product of the tobacco-processing industry

5 Surface of the product of the tobacco-processing industry

6 Particle

6a Position on the surface 5

6b Position on the surface 5

6c Position on the surface 5

6d Position on the projection area 10

7 Device for illumination

8 Device for conveyance

9 Device for evaluation

10 Projection area

12 Imaging device

13 Imaging device

21 Delimiting line for the area recorded by imaging device 2

22 Delimiting line for the area recorded by imaging device 2

31 Delimiting line for the area recorded by imaging device 3

32 Delimiting line for the area recorded by imaging device 3

What is claimed:

1. An apparatus for electromagnetic monitoring of products of tobacco-processing industry in a monitoring zone, comprising:
a first imaging device aligned to the monitoring zone;
a second imaging device aligned to the monitoring zone from a direction different from the first imaging device; and
an evaluating device structured and arranged to evaluate image data recorded by the first and second imaging devices,
wherein at least one of the first and second imaging devices is aligned to at least one product.

2. The apparatus of claim 1, wherein the first and second imaging devices are aligned to the at least one product.

3. The apparatus of claim 1, wherein the first and second imaging devices are aligned to the monitoring zone essentially perpendicular to one another.

4. The apparatus of claim 1, further comprising an apparatus structured and arranged to illuminate the monitoring zone.

5. The apparatus of claim 1, further comprising a conveying apparatus for conveying the at least one product through the monitoring zone.

6. The apparatus of claim 5, wherein the at least one product comprises plural products, and the conveying apparatus conveys the plural products through the monitoring zone in a row, one behind an other, in a single layer.

7. The apparatus of claim 1, wherein the first and second imaging devices comprise optical imaging devices.

8. The apparatus of claim 1, the evaluating device compares first image data of the first imaging device to second image data of the second imaging device.

9. The apparatus of claim 8, wherein the evaluating device is structured and arranged to:
assume a defect on a surface of the at least one product when a first irregularity in the first image data and a second irregularity in the second image data coincide with a point on the surface of the at least one product, and
assume no defect on a surface of the at least one product when no point on the surface of the at least one product coincides with a first irregularity in the first image data and a second irregularity in the second image data.

10. The apparatus of claim 8, wherein the evaluating device is structured and arranged to:
assume a defect in the at least one product when only one of the first and second image data contains an irregularity, and
assumes no defect in the at least one product when both the first and second image data contains an irregularity or when no image data contains an irregularity.

11. A machine of the tobacco-processing industry comprising the apparatus of claim 1.

12. A method of electromagnetic monitoring of products of tobacco-processing industry in a monitoring zone, comprising:
recording a first image of the monitoring zone from a first direction;
recording a second image of the monitoring zone from a second direction different from the first direction, wherein at least one of the first image and the second image includes at least one image of at least one product; and
determining whether there is a defect in the at least one product by evaluating the first image and the second image.

13. The method of claim 12, wherein both the first image and the second image includes at least one image of the at least one product.

14. The method of claim 13, wherein the evaluating comprises assuming a defect on a surface of the at least one product when a first irregularity in the first image and a second irregularity in the second image coincide with a point on the surface of the at least one product.

15. The method of claim 13, wherein the evaluating comprises assuming no defect on a surface of the at least one product when no point on the surface of the at least one product coincides with a first irregularity in the first image and a second irregularity in the second image.

16. The method of claim 12, wherein only the first image includes the at least one image of the at least one product.

17. The method of claim 16, wherein the evaluating comprises assuming a defect on a surface of the at least one product when only the first image contains an irregularity.

18. The method of claim 16, wherein the evaluating comprises assuming no defect on a surface of the at least one product when both the first image and the second image contain an irregularity or when no image contains an irregularity.

19. The method of 12, wherein the at least one product comprises plural products, and further comprising conveying the plural products through the monitoring zone in a row, one behind an other, in a single layer.

20. The method of claim 12, wherein the evaluating comprises comparing the first image and the second image.
